(19) United States
(12) Patent Application Publication
(10) Pub. No.: US 2025/0349044 A1
(43) Pub. Date: Nov. 13, 2025

(54) IMAGE PROCESSING METHOD, ELECTRONIC DEVICE AND STORAGE MEDIUM

(71) Applicant: Beijing Zitiao Network Technology Co., Ltd., Beijing (CN)

(72) Inventors: Jiaxin MA, Beijing (CN); Yujia WANG, Beijing (CN); Jiabin HUANG, Beijing (CN); Shali CHEN, Beijing (CN)

(21) Appl. No.: 18/861,539

(22) PCT Filed: Mar. 14, 2023
(86) PCT No.: PCT/CN2023/081335

§ 371 Date: Oct. 29, 2024

(30) Foreign Application Priority Data
Apr. 29, 2022 (CN) 202210476183.9

(51) Int. Cl. G06T 11/00; G06T 7/90

(52) U.S. Cl. CPC G06T 11/001; G06T 7/90; G06T 2207/10016

(57) ABSTRACT

An image processing method and apparatus, an electronic device, and a storage medium are provided. The image processing method includes: in response to a received special effect configuration triggering operation for configuring a hair highlight special effect, displaying a highlight special effect configuration interface; displaying an image to be processed for configuring the hair highlight special effect in the image preview region; and receiving a dyeing region configuration parameter input based on the region configuration item, and displaying a dyed preview image after dyeing a target dyeing region corresponding to the dyeing region configuration parameter in the image to be processed in the image preview region.

The present disclosure claims the priority of a Chinese patent application filed to the China National Intellectual Property Administration on Apr. 29, 2022, with application number 202210476183.9, and its entire content is incorporated in this disclosure by reference.

### TECHNICAL FIELD

The embodiments of the present disclosure relate to an image processing technology, for example, an image processing method and apparatus, an electronic device, and a storage medium.

### BACKGROUND

In current society, with the popularization of mobile terminals and the acceleration of the network, short video, as a short and smooth way of Internet content transmission, has gradually gained the favor of major platforms and video creators. Short video materials are generally generated from the images or video clips to be displayed. In order to rich the display effect of short videos, special effects are often applied to the images in the short video materials.

Relevant image processing methods often fail to perform refined processing on local information in the image. For example, refined processing of images often requires manual processing of local information in a single image. The entire processing process is very cumbersome and requires a lot of labor costs, with low efficiency. Moreover, manual processing requires a certain level of professionalism for the processing person, resulting in varying effects of image processing from person to person. Moreover, this manual processing method is also difficult to meet the increasing demand for image refined processing.

### SUMMARY

The embodiments of the present disclosure provide an image processing method and apparatus, an electronic device, and a storage medium to meet the personalized needs of hair dyeing.

In the first aspect, the embodiments of the present disclosure provide an image processing method, which includes:
in response to a received special effect configuration triggering operation for configuring a hair highlight special effect, displaying a highlight special effect configuration interface, in which the highlight special effect configuration interface displays an image preview region and at least one highlight configuration item, and the highlight configuration item at least includes a region configuration item for configuring a dyeing region;
displaying an image to be processed for configuring the hair highlight special effect in the image preview region; and
receiving a dyeing region configuration parameter input based on the region configuration item, and displaying a dyed preview image after dyeing a target dyeing region corresponding to the dyeing region configuration parameter in the image to be processed in the image preview region.

In the second aspect, the embodiments of the present disclosure further provide an image processing apparatus, which includes:
an interface display module, configured to display a highlight special effect configuration interface in response to a received special effect configuration triggering operation for configuring a hair highlight special effect, in which the highlight special effect configuration interface displays an image preview region and at least one highlight configuration item, and the highlight configuration item at least comprises a region configuration item for configuring a dyeing region;
an image to be processed display module, configured to display an image to be processed for configuring the hair highlight special effect in the image preview region; and
a dyeing effect display module, configured to receive a dyeing region configuration parameter input based on the region configuration item, and display a dyed preview image after dyeing a target dyeing region corresponding to the dyeing region configuration parameter in the image to be processed in the image preview region.

In the third aspect, the embodiments of the present disclosure further provide an electronic device, which includes:
a processor; and
a storage apparatus, configured to store programs,
the programs are executed by the processor to allow the processor to implement the image processing method provided by any embodiment of the present disclosure.

In the fourth aspect, the embodiments of the present disclosure further provide a computer readable storage medium, the computer readable storage medium stores computer executable instructions, the computer executable instructions are executed by a computer processor to perform the image processing method provided by any embodiment of the present disclosure.

### BRIEF DESCRIPTION OF DRAWINGS

Throughout the drawings, the same or similar reference numbers indicate the same or similar elements. It should be understood that the attached drawings are illustrative, and components and elements may not necessarily be drawn to scale.

FIG. 1 is a flowchart of an image processing method provided by embodiments of the present disclosure;

FIG. 2 is a flowchart of another image processing method provided by embodiments of the present disclosure;

FIG. 3 is a flowchart of another image processing method provided by embodiments of the present disclosure;

FIG. 4 is a flowchart of another image processing method provided by embodiments of the present disclosure;

FIG. 5 is a schematic diagram of a highlight special effect configuration interface provided by embodiments of the present disclosure;

FIG. 6 is a structural block diagram of an image processing apparatus provided by embodiments of the present disclosure;

FIG. 7 is a structural diagram of an electronic device implementing the image processing method provided by embodiments of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes.

It should be understood that various steps recorded in the implementation modes of the method of the present disclosure may be performed according to different orders and/or performed in parallel. In addition, the implementation modes of the method may include additional steps and/or steps omitted or unshown.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of the messages or information exchanged between multiple devices in the embodiments of the present disclosure are for illustrative purposes only and are not intended to limit the scope of these messages or information.

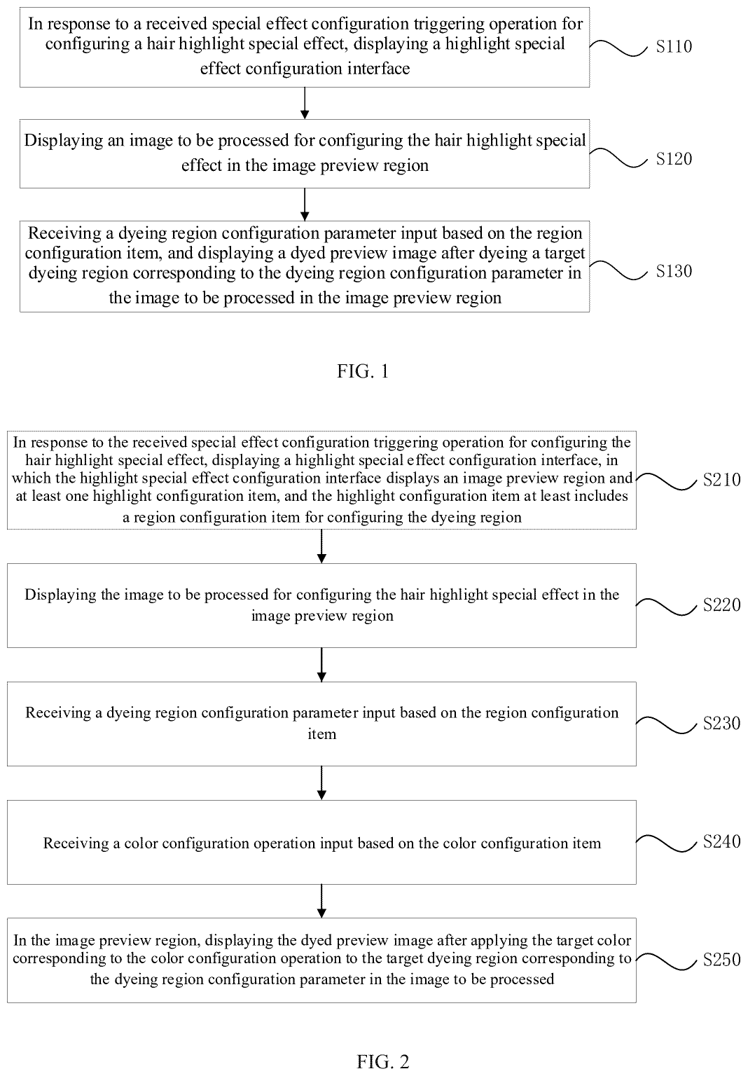

FIG. 1 is a flowchart of an image processing method provided by embodiments of the present disclosure, which is applicable to the case of hair highlight processing. The method can be executed by an image processing apparatus, which can be implemented in the form of software and/or hardware. Optionally, it can be implemented through an electronic device, which may be a mobile terminal, a personal computer (PC) terminal, a server, or the like.

As shown in FIG. 1, the method provided by the embodiments of the present disclosure may include:

S110. in response a received special effect configuration triggering operation for configuring a hair highlight special effect, displaying a highlight special effect configuration interface.

The special effect configuration triggering operation may be a triggering operation for enabling the function of parameter configuration of the hair highlight special effect. The highlight special effect configuration interface may be a user interaction interface used to achieve the operational logic of the parameter configuration of the hair highlight special effect.

Optionally, the highlight special effect configuration interface may display at least one highlight configuration item. The highlight configuration item can be understood as various parameter configuration controls used to set the effect associated with hair highlight. In order to achieve the function of dyeing the designated region of hair, in the embodiments of the present disclosure, the highlight configuration item at least includes a region configuration item for configuring the dyeing region. The region configuration item can be understood as a control providing for users to configure the dyeing region on the hair.

Optionally, the highlight special effect configuration interface may also display an image preview region. The image preview region may include an image display region and an image display control for obtaining the image to be processed. For example, the image display control may be an image capture control for enabling a capture device to capture images in real time and an image upload control for uploading images from a target image library. The image display region can be used to display the image before configuring the hair highlight special effect and the image after configuring the hair highlight special effect, for users to view the effect of hair highlight.

In one embodiment, the image preview region may also be provided with an original image viewing control for viewing the image before applying the hair highlight special effect, or a switching control for switching between displaying the image before configuring the hair highlight special effect and the image after configuring the hair highlight special effect, that is, a control to switch between displaying the image to be processed and the dyed preview image, so that users can compare and view the image effect before configuring the hair highlight special effect and the image effect after configuring the hair highlight special effect at any time.

In the embodiments of the present disclosure, there are multiple ways to generate the special effect configuration triggering operation. All the operations that can enable the function of parameter configuration for the hair highlight special effect after triggering are within the protection scope of the embodiments of the present disclosure.

For example, the received special effect configuration triggering operation for configuring the hair highlight special effect may include: receiving a control triggering operation that acts on a preset special effect triggering control for enabling the hair highlight special effect; or, an operation by inputting a preset special effect enabling command for enabling the hair highlight special effect; or, receiving an interface opening operation for opening the highlight special effect configuration interface. The special effect enabling command may be a command in the form of machine language, or a command in the form of voice, or a command in the form of a preset action, or a command in the form of a touch track, or the like.

S120. displaying an image to be processed for configuring the hair highlight special effect in the image preview region.

The image to be processed may be an image used for performing a hair highlight special effect. As mentioned before, the image display control may include an image capture control for enabling a capture device to capture images in real time and/or an image upload control for uploading images from a target image library. The image display region can be used to display the image obtained through the image display control. In the embodiments of the present disclosure, the image obtained through the image display control may be used as the image to be processed. The image upload control may be an operation control provided in the image preview region for uploading images. For example, the image to be processed can be uploaded by clicking on the preset image upload control. Optionally, the image to be processed can be uploaded by dragging the image to be processed or a video including the image to be processed into the image preview region to display the image to be processed for configuring the hair highlight special effect in the image preview region.

It should be noted that, the image to be processed may be an independent image or an image in a video.

Optionally, displaying the image to be processed for configuring the hair highlight special effect in the image preview region includes: receiving an image upload operation input based on the image upload control in the image preview region, displaying the uploaded image in the image preview region, and taking the uploaded image as the image to be processed for configuring the hair highlight special effect.

In the embodiments of the present disclosure, users upload the image to be processed to the image preview region through an image upload operation in the image preview region of the highlight special effect configuration interface, and display the image to be processed in the image preview region, so that users can more intuitively confirm the configuration object used to configure the hair highlight special effect.

Optionally, displaying the image to be processed for configuring the hair highlight special effect in the image preview region includes: receiving a video upload operation input based on the video upload control in the image preview region, displaying the uploaded video in the image preview region, and taking an image in the uploaded video that meets a preset condition as the image to be processed for configuring the hair highlight special effect.

The video upload control may be an operation control provided in a video preview region for uploading videos. The video upload operation may be an operation for video upload by triggering the video upload control. For example, the video upload control can be triggered by clicking or pressing.

In the embodiments of the present disclosure, users upload the video to be uploaded to the image preview region by triggering the video upload operation of the video upload control in the video preview region of the highlight special effect configuration interface, and the uploaded video is displayed in the image preview region.

Generally, a video includes multiple frames of images. In the embodiments of the present disclosure, the image that meets the preset condition in the uploaded video can be used as the image to be processed for configuring the hair highlight special effect. The preset condition can be set according to actual needs. For example, the preset condition may be all images in the video that include the target processing object, or each frame of the video, or a preset number of images in the video or images within a preset playback time range, and so on. For example, image recognition may be performed on each frame of image in the uploaded video through the video preview region to determine the image that meets the preset condition in the uploaded video. The image that meets the preset condition in the uploaded video can be used as the image to be processed for configuring the hair highlight special effect.

S130. receiving a dyeing region configuration parameter input based on the region configuration item, and displaying a dyed preview image after dyeing a target dyeing region corresponding to the dyeing region configuration parameter in the image to be processed in the image preview region.

The dyeing region configuration parameter may be a region determination parameter used to determine which region of the hair in the image to be processed is to be dyed. For example, the dyeing region parameter can be represented by a region identification, such as a whole head region, an outer ear region, an inner ear region, a left ear region, and a right ear region. The dyed preview image may be an image to be processed after dyeing a region corresponding to the dyeing region configuration parameter in the image to be processed through a region configuration item.

In the embodiments of the present disclosure, users can input the dyeing region configuration parameter through the region configuration item in the highlight special effect configuration interface, and then take the region that matches the dyeing region configuration parameter in the region corresponding to the image to be processed as a target dyeing region to perform dyeing according to the dyeing region configuration parameter, and then a dyed preview image is displayed after dyeing in the image preview region, so that the users can view the effect after dyeing.

In some embodiments, the color dyed in the target dyeing region may be a default fixed color in the background, or a randomly matched color, or a color determined based on preset color matching rules. The color determined based on preset color matching rules can be determined according to the image background color in the image to be processed, skin color, or user's historical dyeing data.

In order to better adapt to user needs, optionally, in another embodiment of the present disclosure, the highlight configuration item further includes a color configuration item and/or a transparency configuration item for the convenience of users to personalize the color of the target dyeing region and the transparency of the dyed color.

In addition, the highlight configuration item may also include an object selection control for processing objects, to allow users to select the target processing object in the image to be processed. It can be understood that when there are multiple processable objects in the image to be processed, the target processing object can be accurately selected. For example, when the image to be processed includes two processable hair regions, the object to be processed can be selected by the object selection control. It can be understood that the object selection control can be used to select one target processing object or multiple target processing objects.

In the embodiments of the present disclosure, optionally, the highlight special effect configuration interface may include a plurality of region configuration items. Each region configuration item corresponds to a dyeing region parameter, and each dyeing region configuration parameter corresponds to a dyeing region. The input dyeing region configuration parameter can be determined by the selection operation input for various region configuration items. In other words, receiving the dyeing region configuration parameter input based on the region configuration item may be to receive the selection operation for the plurality of region configuration items displayed in the highlight special effect configuration interface, and to obtain the dyeing region configuration parameter corresponding to the selected region configuration item.

The way to display the dyed preview image after dyeing the target dyeing region corresponding to the dyeing region configuration parameter in the image to be processed in the image preview region may be dynamic display or static display. The dynamic display can be achieved after overlaying preset dynamic elements on the dyed preview image, or based on the dyed preview image generating a motion picture.

In the technical solution of the embodiments of the present disclosure, a highlight special effect configuration interface is displayed in response to the received special effect configuration triggering operation for configuring the hair highlight special effect. Since the highlight special effect configuration interface displays an image preview region and at least one highlight configuration item, the highlight configuration item includes at least a region configuration item for configuring the dyeing region, which can provide users with the function of selecting the hair dyeing region and interact with users to more accurately obtain user needs. Displaying the image to be processed for configuring the hair highlight special effect in the image preview region enables users to intuitively view the image to be processed in the highlight special effect configuration interface, and receiving the dyeing region configuration parameter input based on the region configuration item, displaying a dyed preview image after dyeing the target dyeing region corresponding to the dyeing region configuration parameter in the image to be processed in the image preview region, which can generate the dyed preview image according to the user's dyeing region configuration parameter, and display different hair highlight special effects. In the technical solution of the present disclosure, the selected region of hair can be automatically dyed only through the dyeing region configuration parameter input by users through the region configuration item, this interaction method is simple, the universality is strong, the manual processing time of users is saved, the generation efficiency of the hair highlight special effect is improved, and the technical problems of the related technology in terms of the professional requirements, time-consuming and laborious problem as well as the unstable processing effect of the fine processing of the local information of the image are solved. Simple and fast hair dyeing is achieved, the personalized hair dyeing needs of users are met, and the user experience is improved.

FIG. 2 is a flowchart of another image processing method provided by the embodiments of the present disclosure. In the technical solution of this embodiment, a highlight configuration item is added on the basis of any optional technical solution in the embodiments of the present disclosure. Optionally, the highlight configuration item also includes a color configuration item and/or a transparency configuration item. This can make the parameter configuration for hair dyeing more diverse by configuring the color configuration item and/or the transparency configuration item.

Optionally, the image processing method of the embodiments of the present disclosure may further include: receiving a color configuration operation input based on the color configuration item; correspondingly, displaying the dyed preview image after dyeing the target dyeing region corresponding to the dyeing region configuration parameter in the image to be processed in the image preview region may include: in the image preview region, displaying the dyed preview image after applying a target color corresponding to the color configuration operation to the target dyeing region corresponding to the dyeing region configuration parameter in the image to be processed. The technical features same as or corresponding to the technical features in the above embodiments will not be repeated.

As shown in FIG. 2, the image processing method of the embodiments of the present disclosure may include:

S210. in response to the received special effect configuration triggering operation for configuring the hair highlight special effect, displaying a highlight special effect configuration interface, in which the highlight special effect configuration interface displays an image preview region and at least one highlight configuration item, and the highlight configuration item at least includes a region configuration item for configuring the dyeing region.

S220. displaying the image to be processed for configuring the hair highlight special effect in the image preview region.

S230. receiving a dyeing region configuration parameter input based on the region configuration item.

S240. receiving a color configuration operation input based on the color configuration item.

The color configuration item is used to configure the color to be dyed in the target dyeing region, that is, the target color.

In the embodiments of the present disclosure, the color configuration item can be displayed in various ways in the highlight special effect configuration interface, such as a color identification input frame, a strip color card, a circular color selection card, and a color drop-down selection frame. For example, there may be multiple ways to receive the color configuration operation input based on the color configuration item. For example, the ways may be to receive the color selection operation for the strip color card, the circular color selection card, or the color drop-down selection frame; or, to receive the operation of inputting a color identification for the color identification input frame, and so on. The generation method of the color selection operation may be to generate through the clicking operation for the color, or to generate through scrolling the mouse after selecting the color configuration item, or to generate through triggering the color switching control.

S250. in the image preview region, displaying the dyed preview image after applying the target color corresponding to the color configuration operation to the target dyeing region corresponding to the dyeing region configuration parameter in the image to be processed.

Applying the target color corresponding to the color parameter of the color configuration item in the region configuration item to the target dyeing region corresponding to the dyeing region configuration parameter can be understood as dyeing the target color corresponding to the color configuration operation on the target dyeing region corresponding to the dyeing region configuration parameter.

When users configure the hair highlight special effect in the highlight special effect configuration interface, the highlight special effect configuration interface can be set with the default color parameter and/or transparency parameter corresponding to the region configuration item. Users can choose to adjust the color configuration item or the transparency configuration item separately, or choose to configure the color configuration item and the transparency configuration item simultaneously.

In the case where the highlight configuration item includes a transparency configuration item, as an optional embodiment, the image processing method of the embodiments of the present disclosure may further include: receiving a transparency configuration operation input based on the transparency configuration item; correspondingly, displaying the dyed preview image after dyeing the target dyeing region corresponding to the dyeing region configuration parameter in the image to be processed in the image preview region includes: in the image preview region, displaying a dyed preview image after applying the target color transparency corresponding to the transparency configuration operation to the target color dyed in the target dyeing region corresponding to the dyeing region configuration parameter in the image to be processed.

The transparency configuration item is used to configure the color transparency of the color to be dyed in the target dyeing region, that is, the target color transparency.

Optionally, in the embodiments of the present disclosure, the target transparency configured by the user through the transparency configuration item of the highlight special effect configuration interface is applied to the target color configured through the color configuration item, and then the target color is applied to the target dyeing region corresponding to the dyeing region configuration parameter, thus, the dyed preview image after the transparency adjustment of the target dyeing region is presented in the image preview region.

It should be noted that, in the embodiments of the present disclosure, users can simultaneously perform highlight configuration on both the color configuration item and the transparency configuration item. According to the target color input by the user based on the color configuration item and the color transparency input based on the transparency configuration item, the dyed preview image after dyeing the target dyeing region in the image to be processed with the target color having the input color transparency is displayed.

Optionally, when users perform the highlight configuration in the highlight special effect configuration interface, the highlight special effect configuration interface may also provide a recommended color for configuring hair highlight in the region configuration item and a recommended color transparency corresponding to the recommended color parameter, thereby providing a reference for users to choose a more suitable hair highlight special effect.

The technical solution of the embodiments of the present disclosure can not only configure the hair dyeing region, but also configure the color dyed in the target dyeing region, which can better meet the personalized needs of users. Moreover, on this basis, color transparency can be added to adjust the dyed target color, making the hair dyeing effect more natural and improving the user experience.

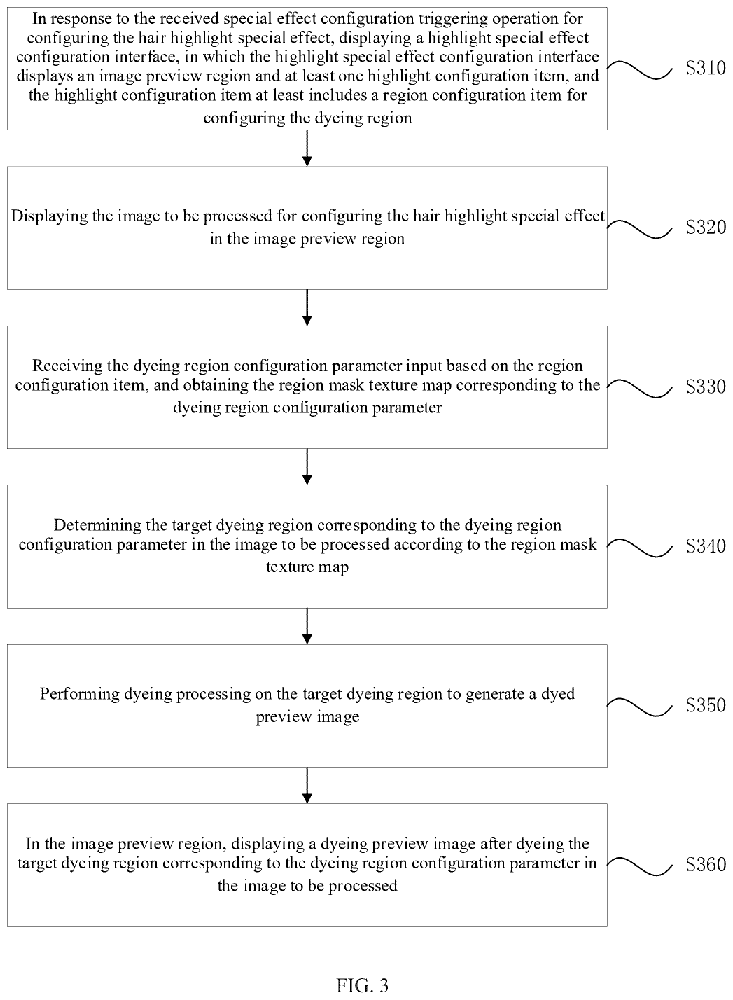

FIG. 3 is a flowchart of another image processing method provided by the embodiments of the present disclosure. On the basis of any optional technical solution in the embodiments of the present disclosure, the technical solution of this embodiment refines how to quickly and accurately generate a dyed preview image. Optionally, after receiving the dyeing region configuration parameter input based on the region configuration item, and before displaying the dyed preview image after dyeing the target dyeing region corresponding to the dyeing region configuration parameter in the image to be processed in the image preview region, the method further includes: obtaining a region mask texture map corresponding to the dyeing region configuration parameter, determining the target dyeing region corresponding to the dyeing region configuration parameter in the image to be processed according to the region mask texture map, and performing dyeing processing on the target dyeing region to generate a dyed preview image. The technical features same as or corresponding to the technical features in the above embodiments will not be repeated.

As shown in FIG. 3, the technical solution of this embodiment may include:

S310. in response to the received special effect configuration triggering operation for configuring the hair highlight special effect, displaying a highlight special effect configuration interface, in which the highlight special effect configuration interface displays an image preview region and at least one highlight configuration item, and the highlight configuration item at least includes a region configuration item for configuring the dyeing region.

S320. displaying the image to be processed for configuring the hair highlight special effect in the image preview region.

S330. receiving the dyeing region configuration parameter input based on the region configuration item, and obtaining the region mask texture map corresponding to the dyeing region configuration parameter.

The region mask texture map includes a mask texture map of all hair regions and a mask texture map of at least one local hair region.

Optionally, obtaining the region mask texture corresponding to the dyeing region configuration parameter includes: recognizing the image to be processed through a pre-trained neural network model corresponding to the dyeing region configuration parameter, and determining the region mask texture map of the current image to be processed. For example, the region mask texture map may include a mask texture map for overall hair segmentation, a left outer ear mask texture map, a right outer ear mask texture map, a left inner ear mask texture map, and a right inner ear mask texture map.

In the embodiments of the present disclosure, a neural network model can be trained for each dyeing region configuration parameter to identify the dyeing region corresponding to the dyeing region configuration parameter in the image to be processed. For example, the pre-trained neural network model may be an image processing model, which can be obtained by training based on a neural network structure. For example, a convolutional neural network (CNN) can be used to train the image processing model.

Before training the image processing model, a large number of images containing faces and hair and a region mask texture map that has been image processed are collected as training samples. During the training process, images containing faces and hair are input into the image processing model to be trained, and the trained region mask texture map output by the image processing model to be trained is obtained. A loss calculating process is performed on the output region mask texture map and the region mask texture map that has been image processed through a loss function, and the parameters in the image processing model to be trained are adjusted according to the calculated loss. When the convergence of the loss function in the image processing model to be trained is detected, the training of the image processing model to be trained is completed, and the image processing model is obtained.

The loss function of the image processing model may include any one of the mean square error function, mean absolute error function, and cross entropy error function.

S340. determining the target dyeing region corresponding to the dyeing region configuration parameter in the image to be processed according to the region mask texture map.

In the embodiments of the present disclosure, the value in the R (red) or A (transparency) channel of the region mask texture map of the image to be processed can be obtained. Whether the pixels in the region mask texture map belong to the target dyeing region is determined according to the value in the R or A channel of the region mask texture map. For example, the value in the R or A channel may be [0, 1], 0 represents that it is not the target dyeing region and 1 represents that it is the target dyeing region.

Optionally, the target dyeing region corresponding to the dyeing region configuration parameter in the image to be processed is determined according to the region mask texture map. For example, various pixels to be dyed in the image to be processed are determined according to the UV coordinates of various pixels belonging to the target dyeing region in the region mask texture map, and the region composed of the various pixels to be dyed in the image to be processed is determined as the target dyeing region corresponding to the dyeing region configuration parameter.

S350. performing dyeing processing on the target dyeing region to generate a dyed preview image.

For each pixel in the target dyeing region, the original color value of the pixel is fused with the color value of the color to be dyed in the target dyeing region to obtain a target color value of the pixel. Optionally, fusing the original color value of the pixel with the color value of the color to be dyed in the target dyeing region includes: fusing the original color value of the pixel with the color value of the color to be dyed in the target dyeing region according to a preset fusion operation rule. The preset fusion operation rule includes at least one of sum operation, weighted sum operation, product operation, and weighted product operation.

When performing dyeing processing on the target dyeing region and generating a dyed preview image, optionally, the image processing method of the embodiments of the present disclosure may further include: adjusting the color to be dyed in the target dyeing region according to a preset color adjustment curve; and/or, adjusting the color of the target dyeing region after dyeing according to a preset color adjustment curve. This setting can increase the contrast of the image, for example, making bright regions brighter and dark regions darker, resulting in better smoothing effects. Then, the target dyeing region is colored by the adjusted color to obtain the dyed preview image.

For example, the preset color adjustment curve can be understood as a curve used to adjust the brightness or saturation of a color. For example, the preset color adjustment curve may be an adjustment curve generated based on a color Look-Up-Table (LUT).

For example, before performing dyeing processing on the target dyeing region, the color to be dyed in the target dyeing region is adjusted according to the preset color adjustment curve, and/or after performing dyeing processing on the target dyeing region, the color of the target dyeing region after dyeing can be adjusted according to the preset color adjustment curve.

For example, after determining the target dyeing region corresponding to the dyeing region configuration parameter in the image to be processed, the color to be dyed in the target dyeing region can be adjusted according to the preset color adjustment curve, and then the target dyeing region can be dyed based on the adjusted color to generate the dyed preview image; or, after determining the target dyeing region corresponding to the dyeing region configuration parameter in the image to be processed, the target dyeing region can be dyed, and then the color of the dyed target dyeing region is adjusted according to the preset color adjustment curve to generate the dyed preview image based on the adjusted color; or, after determining the target dyeing region corresponding to the dyeing region configuration parameter in the image to be processed, the color to be dyed in the target dyeing region is adjusted according to the preset color adjustment curve, and then the target dyeing region is dyed based on the adjusted color, and the color of the dyed target dyeing region is adjusted according to the preset color adjustment curve to generate the dyed preview image based on the adjusted color.

S360. in the image preview region, displaying a dyeing preview image after dyeing the target dyeing region corresponding to the dyeing region configuration parameter in the image to be processed.

It can be understood that the dyed preview image generated by performing the above steps is the dyed preview image after dyeing the target dyeing region corresponding to the dyeing region configuration parameter in the image to be processed.

In the embodiments of the present disclosure, upon receiving a special effect configuration triggering operation for configuring the hair highlight special effect, in response to the received special effect configuration triggering operation for configuring the hair highlight special effect, the highlight special effect configuration interface is displayed. Users view the image to be processed of the hair highlight special effect in the image preview region of the highlight special effect configuration interface. Through the image preview region of the highlight special effect configuration interface, users can intuitively select the hair region they want to highlight in the image to be processed, and then input the dyeing region configuration parameter in the region configuration item. Then, the corresponding region mask texture map can be obtained through a pre-trained neural network model. According to the region mask texture map, the target dyeing region corresponding to the dyeing region configuration parameter is determined. Through the region mask texture map, the dyeing region in the hair is finely distinguished, at the same time, the target dyeing region corresponding to the dyeing region configuration parameter is accurately located according to the region mask texture map, so as to perform dyeing processing on the target dyeing region, and display the dyed preview image after dyeing the target dyeing region corresponding to the dyeing region configuration parameter in the image to be processed in the image preview region, which improves the refinement level of the hair highlight special effect and achieves fine dyeing of various regions of hair.

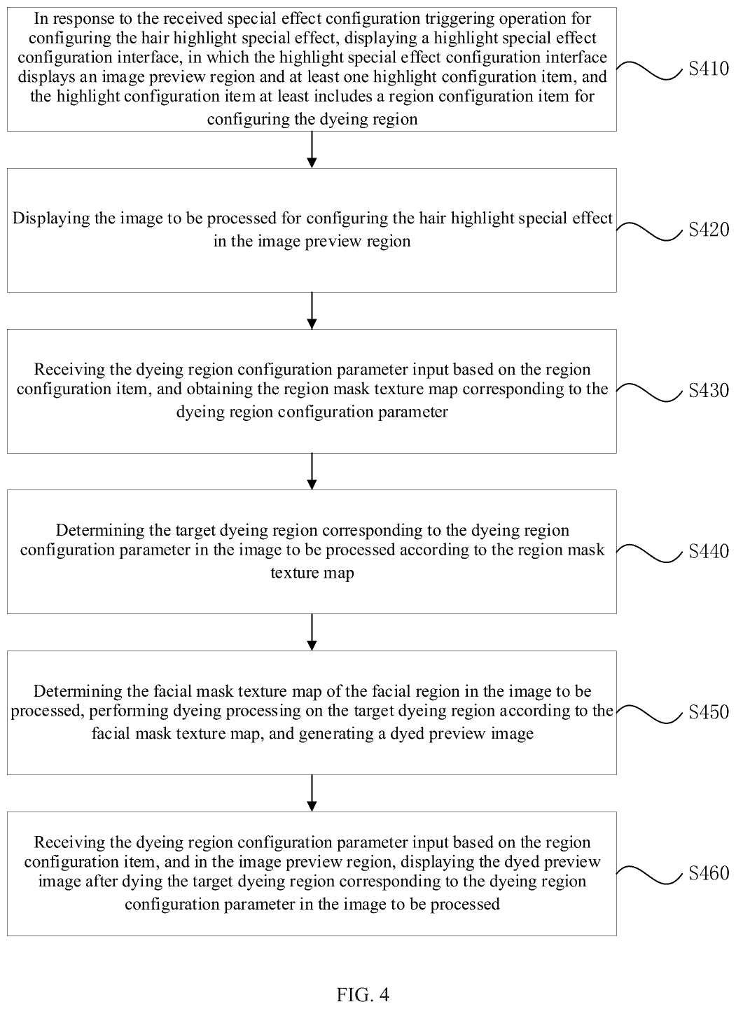

FIG. 4 is a flowchart of another image processing method provided in the embodiment 3 of the present disclosure. On the basis of any optional technical solution in the embodiments of the present disclosure, the technical solution of this embodiment focuses on how to mask the facial region to more accurately ensure the refinement of the dyeing effect. Optionally, performing dyeing processing on the target dyeing region includes: determining a facial mask texture map of the facial region in the image to be processed, and dyeing the target dyeing region according to the facial mask texture map. The technical features same as or corresponding to the technical features in the above embodiments will not be repeated.

As shown in FIG. 4, the technical solution of this embodiment may include:

S410. in response to the received special effect configuration triggering operation for configuring the hair highlight special effect, displaying a highlight special effect configuration interface, in which the highlight special effect configuration interface displays an image preview region and at least one highlight configuration item, and the highlight configuration item at least includes a region configuration item for configuring the dyeing region.

S420. displaying the image to be processed for configuring the hair highlight special effect in the image preview region.

S430. receiving the dyeing region configuration parameter input based on the region configuration item, and obtaining the region mask texture map corresponding to the dyeing region configuration parameter.

S440. determining the target dyeing region corresponding to the dyeing region configuration parameter in the image to be processed according to the region mask texture map.

S450. determining the facial mask texture map of the facial region in the image to be processed, performing dyeing processing on the target dyeing region according to the facial mask texture map, and generating a dyed preview image.

Optionally, the image to be processed is recognized through a pre-trained neural network model to determine the region mask texture map of the current image to be processed. Alternatively, the facial region of the image to be processed is recognized through a facial recognition algorithm, and the facial region is treated as a non-dyeing region. The facial mask texture map is obtained by setting the pixel values of the non-dyeing region to 0 or 1.

The facial mask texture map includes at least a border region between the facial region and the hair in the image to be processed. For example, the border region is a forehead region or an ear region and so on. The embodiments of the present disclosure may also use a facial mask texture map to cover the facial region in the current image to be processed when dyeing the target dyeing region, thereby protecting the facial region and preventing the facial region from dyeing.

Optionally, performing dyeing processing on the target dyeing region according to the facial mask texture map includes: determining an overlapping region between the target dyeing region and the facial mask texture map, and performing dyeing processing on area region of the target dyeing region other than the overlapping region.

Optionally, according to the above embodiments of the present disclosure, the UV coordinates of pixels of the target dyeing region in the image to be processed are obtained, and the UV coordinates of each pixel of the facial mask texture map is also obtained at the same time. The facial region in the image to be processed is determined through the UV coordinates of each pixel of the facial mask texture map. Then, the UV coordinates of pixels of the target dyeing region in the image to be processed are matched with the facial region, the region corresponding to the successfully matched UV coordinates is used as the overlapping region between the target dyeing region and the facial mask texture map, and the region of the target dyeing region other than the overlapping region is dyed.

Optionally, in another embodiment of the present disclosure, after obtaining the UV coordinates of each pixel of the facial mask texture map and the UV coordinates of the pixels in the image to be processed, the UV coordinates of the pixels of the target dyeing region in the current image to be processed are directly matched with the UV coordinates of each pixel of the facial mask texture map. The region corresponding to the successfully matched UV coordinates is used as the overlapping region between the target dyeing region and the facial mask texture map, and the region of the target dyeing region other than the overlapping region is dyed.

Optionally, performing dyeing processing on the region of the target dyeing region other than the overlapping region includes: for each pixel of the region in the target dyeing region other than the overlapping region, fusing the original color value of the pixel with the color value of the color to be dyed in the target dyeing region to obtain the target color value of the pixel.

The original color value can be the original color value of pixels in the target dyeing region. The color value of the color to be dyed can be the color value that needs to be dyed on the hair, for example, it can be the color value of the target color corresponding to the color configuration operation.

Optionally, fusing the original color value of the pixel with the color value of the color to be dyed in the target dyeing region includes: fusing the original color value of the pixel with the color value of the color to be dyed in the target dyeing region according to a preset fusion operation rule. The preset fusion operation rule includes at least one of sum operation, weighted sum operation, product operation, and weighted product operation.

Optionally, in another embodiment of the present disclosure, for each pixel in the region of the target dyeing region other than the overlapping region, the color value of the color to be dyed of the pixel may be used as the target color value.

S460. receiving the dyeing region configuration parameter input based on the region configuration item, and in the image preview region, displaying the dyed preview image after dying the target dyeing region corresponding to the dyeing region configuration parameter in the image to be processed.

As mentioned before, the dyed preview image generated by performing the above steps is the dyed preview image after dyeing the target dyeing region corresponding to the dyeing region configuration parameter in the image to be processed.

In the embodiments of the present disclosure, upon receiving a special effect configuration triggering operation for configuring the hair highlight special effect, in response to the received special effect configuration triggering operation for configuring the hair highlight special effect, the highlight special effect configuration interface is displayed. Users view the image to be processed of the hair highlight special effect in the image preview region of the highlight special effect configuration interface. Through the image preview region of the highlight special effect configuration interface, users can intuitively select the hair region they want to highlight in the image to be processed, and then input the dyeing region configuration parameter in the region configuration item. Then, the corresponding region mask texture map can be obtained through a pre-trained neural network model, and a facial mask texture map is also obtained. According to the region mask texture map and the facial mask texture map, the dyeing region of the target dyeing region, corresponding to the dyeing region configuration parameter, other than the overlapping region is determined, so as to protect the facial region and prevent the facial region from dyeing, which solves the problem of dyeing the skin on the forehead that may occur when the hair is dyed, improves the refinement level of the hair highlight special effect and achieves fine highlight of the target dyeing region of hair.

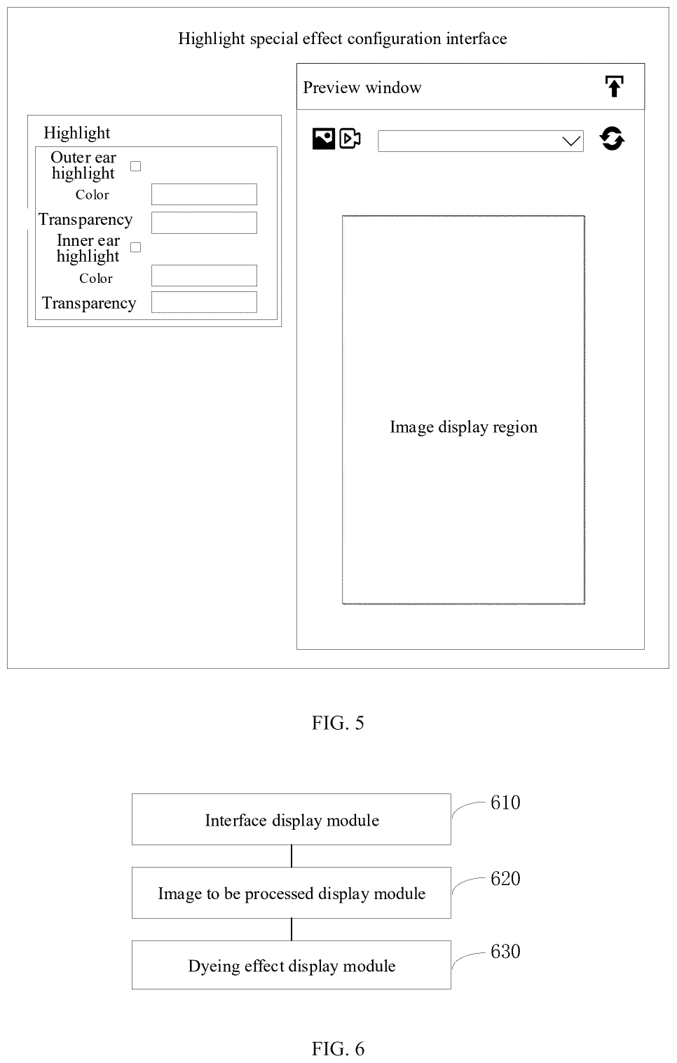

FIG. 5 is a schematic diagram of a highlight special effect configuration interface provided by the embodiments of the present disclosure. As shown in FIG. 5, the highlight special effect configuration interface includes a region configuration item and an image preview region (i.e., a preview window).

The preview window includes: an image upload control, a video upload control, an image selection control, a refresh control, and an image display region for displaying the preview image. Users can click on the image upload control in the image preview window to select the image to upload, and then the image uploaded by the user can be displayed in the image display region; in the case where the image uploaded by the user is a video, users select the video button control and the video uploaded by the user is displayed in the image display region. The users can select the image in the video for processing or the image in the video is automatically recognized based on preset logic for processing. After configuring the corresponding target dyeing region, target color, and target color transparency in the highlight configuration item, the users can click the refresh control to generate a dyed preview image according to the target dyeing region, target color, and target color transparency configured by the users, and display the dyed preview image in the image display region.

The highlight configuration item includes: local hair highlight regions (such as the outer ear highlight and the inner ear highlight in FIG. 5), a color input frame, and a transparency input frame. Users can select the target dyeing region through the configuration item of the local hair highlight regions in the preview window, and also reverse select the configuration item of the local hair highlight region corresponding to the selected dyeing position by selecting the dyeing position of the image to be processed displayed in the image display region. Users may input the color value to be dyed in the color input frame, or may also select the color value to be dyed in the color selector provided in the highlight special effect configuration interface, that is, the target color. Users may input the target color transparency in the transparency input frame, or may also select the target color transparency through the transparency selector provided in the highlight special effect configuration interface.

For example, assuming that according to the “hp_ger_channel_ids” configuration of the algorithm model, five separate region mask texture maps (namely the left outer ear mask texture map mask0, the right outer ear mask texture map mask1, the left inner ear mask texture map mask2, and the right inner ear mask texture map mask3) corresponding to the hair region of the image to be processed can be returned. The fifth mask texture map is always the mask texture map mask4 of the overall hair segmentation. Furthermore, when sampling in the shader, the value [0,1] in the R channel of the region mask texture map is get, where 0 indicates that it is not the target highlight region and 1 indicates that it is the target highlight region. Furthermore, the color value of the target color can be adjusted to achieve a better smoothing effect. Finally, the highlight region is colored and the dyed preview image after applying the corresponding target color and target color transparency in the color input frame and the transparency input frame to the target color dyed in the target dyeing region corresponding to the dyeing region configuration parameter in the image to be processed is displayed in the image preview region.

Since the region returned by the region mask texture map may cover the forehead part, causing the forehead part to also be colored, in order to handle this situation, the technical solution of the embodiments of the present disclosure provides a layer of mask protection to the cheeks. The facial mask texture map is used to prevent coloring in regions with skin, thereby ensuring the accuracy of the hair highlight special effect and achieving fine highlight of the hair.

FIG. 6 is a structural schematic diagram of the e of an image processing apparatus provided by the embodiments of the present disclosure. As shown in FIG. 6, the apparatus may include an interface display module 610, an image to be processed display module 620, and a dyeing effect display module 630.

The interface display module 610 is configured to display a highlight special effect configuration interface in response to a received special effect configuration triggering operation for configuring a hair highlight special effect. The highlight special effect configuration interface displays an image preview region and at least one highlight configuration item. The highlight configuration item at least includes a region configuration item for configuring a dyeing region; the image to be processed display module 620 is configured to display an image to be processed for configuring the hair highlight special effect in the image preview region; the dyeing effect display module 630 is configured to receive a dyeing region configuration parameter input based on the region configuration item, and display the dyed preview image after dyeing the target dyeing region corresponding to the dyeing region configuration parameter in the image to be processed in the image preview region.

In the technical solution of the embodiments of the present disclosure, a highlight special effect configuration interface is displayed in response to the received special effect configuration triggering operation for configuring the hair highlight special effect. Since the highlight special effect configuration interface displays an image preview region and at least one highlight configuration item, the highlight configuration item includes at least a region configuration item for configuring the dyeing region, which can provide users with the function of selecting the hair dyeing region and interact with users to more accurately obtain user needs. Displaying the image to be processed for configuring the hair highlight special effect in the image preview region enables users to intuitively view the image to be processed in the highlight special effect configuration interface, and receiving the dyeing region configuration parameter input based on the region configuration item, displaying a dyed preview image after dyeing the target dyeing region corresponding to the dyeing region configuration parameter in the image to be processed in the image preview region, which can generate the dyed preview image according to the user's dyeing region configuration parameter, and display different hair highlight special effects. In the technical solution of the present disclosure, the selected region of hair can be automatically dyed only through the dyeing region configuration parameter input by users through the region configuration item, this interaction method is simple, the universality is strong, the manual processing time of users is saved, the generation efficiency of the hair highlight special effect is improved, and the technical problems of the related technology in terms of the professional requirements, time-consuming and laborious problem as well as the unstable processing effect of the fine processing of the local information of the image are solved. Simple and fast hair dyeing is achieved, the personalized hair dyeing needs of users are met, and the user experience is improved.

Optionally, the image to be processed display module 620 is configured to determine the image to be processed for configuring the hair highlight special effect in the following way:
receiving an image upload operation input based on an image upload control in the image preview region, displaying the uploaded image in the image preview region, and taking the uploaded image as the image to be processed for configuring the hair highlight special effect; or,
receiving a video upload operation input based on a video upload control in the image preview region, displaying the uploaded video in the image preview region, and taking the image in the uploaded video that meets the preset condition as the image to be processed for configuring the hair highlight special effect.

Optionally, the highlight configuration item also includes a color configuration item and/or a transparency configuration item.

Optionally, the apparatus further includes:
a color configuration module, configured to receive a color configuration operation input based on the color configuration item.

Correspondingly, the dyeing effect display module 630 is configured to display the dyed preview image in the following way:
in the image preview region, displaying the dyed preview image after applying the target color corresponding to the color configuration operation to the target dyeing region corresponding to the dyeing region configuration parameter in the image to be processed.

Optionally, the apparatus further includes:
a transparency configuration module, configured to receive a transparency configuration operation input based on the transparency configuration item.

Correspondingly, the dyeing effect display module 630 is also configured to display the dyed preview image in the following way:
in the image preview region, displaying the dyed preview image after applying the target color transparency corresponding to the transparency configuration operation to the target color dyed in the target dyeing region corresponding to the dyeing region configuration parameter in the image to be processed.

Optionally, the apparatus may also include:
a region mask module, configured to, after receiving the dyeing region configuration parameter input based on the region configuration item, and before displaying the dyed preview image after dyeing the target dyeing region corresponding to the dyeing region configuration parameter in the image to be processed in the image preview region, obtain a region mask texture map corresponding to the dyeing region configuration parameter, determine a target dyeing region corresponding to the dyeing region configuration parameter in the image to be processed according to the region mask texture map, and perform dyeing processing on the target dyeing region to generate the dyed preview image.

Optionally, the target mask texture map includes a mask texture map of all hair regions and a mask texture map of at least one local hair region.

Optionally, the region mask module is configured to perform dyeing processing on the target dyeing region according to the facial mask texture map in the following way:
determining a facial mask texture map of the facial region in the image to be processed, and performing dyeing processing on the target dyeing region according to the facial mask texture map.

Optionally, the region mask module is configured to perform dyeing processing on the region of the target dyeing region other than the overlapping region in the following way:
determining an overlapping region between the target dyeing region and the facial mask texture map, and performing dyeing processing on the region of the target dyeing region other than the overlapping region.

Optionally, the region mask module is configured to fuse color values in the following way:
for each pixel in the region of the target dyeing region other than the overlapping region, fusing the original color value of the pixel with the color value of the color to be dyed in the target dyeing region, to obtain the target color value of the pixel.

Optionally, the region mask module is configured to fuse color values according to the preset fusion operation rule in the following way:
fusing the original color value of the pixel with the color value of the color to be dyed in the target dyeing region according to the preset fusion operation rule. The preset fusion operation rule includes at least one of sum operation, weighted sum operation, product operation, and weighted product operation.

Optionally, the apparatus further includes:
a color adjustment module, configured to adjust the color to be dyed in the target dyeing region according to a preset color adjustment curve; and/or, adjust the color of the target dyeing region after dyeing according to the preset color adjustment curve.

The image processing apparatus provided by the embodiments of the present disclosure can execute any image processing method provided by the embodiments of the present disclosure, and has corresponding functional modules and beneficial effects for executing the image processing method.

It is worth noting that in the embodiments of the image processing apparatus mentioned above, the various units and modules included are only divided according to functional logic, but are not limited to the above division, as long as the corresponding functions can be implemented. In addition, the names of various functional units are only for the purpose of distinguishing them from each other.

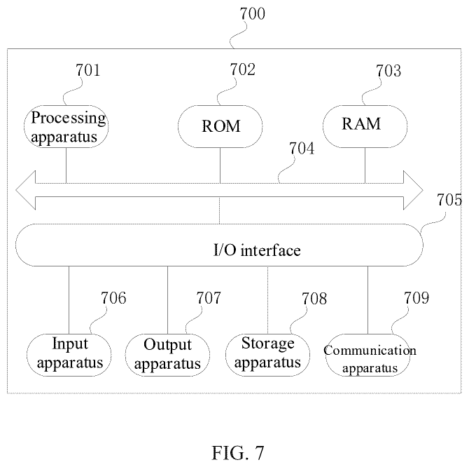

FIG. 7 is a structural diagram of an electronic device provided by the embodiments of the present disclosure. Refer to FIG. 7, it shows the structural schematic diagram suitable for achieving the electronic device (for example, the terminal device or the server) 700 in the embodiments of the present disclosure. The terminal device in the embodiments of the present disclosure may include but not be limited to a mobile terminal such as a mobile phone, a notebook computer, a digital broadcasting receiver, a personal digital assistant (PDA), a portable android player (PAD), a portable media player (PMP), a vehicle terminal (such as a vehicle navigation terminal), and a fixed terminal such as a digital television (TV) and a desktop computer. The electronic device shown in FIG. 7 is only an example.

As shown in FIG. 7, the electronic device 700 may include a processing apparatus (such as a central processing unit, and a graphics processor) 701, the processing apparatus 701 may execute various appropriate actions and processes according to a program stored in a read-only memory (ROM) 702 or a program loaded from a storage apparatus 708 to a random access memory (RAM) 703. In RAM 703, various programs and data required for operations of the electronic device 700 are also stored. The processing apparatus 701, ROM 702, and RAM 703 are connected to each other by a bus 704. An input/output (I/O) interface 705 is also connected to the bus 704.

Typically, the following apparatuses may be connected to the I/O interface 705: an input apparatus 706 such as a touch screen, a touchpad, a keyboard, a mouse, a camera, a microphone, an accelerometer, and a gyroscope; an output apparatus 707 such as a liquid crystal display (LCD), a loudspeaker, and a vibrator; a storage apparatus 708 such as a magnetic tape, and a hard disk drive; and a communication apparatus 709. The communication apparatus 709 may allow the electronic device 700 to wireless-communicate or wire-communicate with other devices so as to exchange data. Although FIG. 7 shows the electronic device 700 with various apparatuses, it should be understood that it is not required to implement or possess all the apparatuses shown. Alternatively, it may implement or possess the more or less apparatuses.

In one embodiment, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the methods of some embodiments of the present disclosure are performed.

The electronic device provided by the embodiments of the present disclosure and the image processing method provided by the above embodiments belong to the same inventive concept. Technical details not fully described in this embodiment can be found in the above embodiments, and this embodiment has the same beneficial effects as the above embodiments.

The embodiments of the present disclosure provide a computer storage medium, which stores computer executable instructions, the computer executable instructions are executed by a computer processor to perform the image processing method provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: in response to a received triggering operation for configuring a hair highlight special effect, display a highlight special effect configuration interface, in which the highlight special effect configuration interface displays an image preview region and at least one highlight configuration item, and the highlight configuration item at least includes a region configuration item for configuring a dyeing region; display an image to be processed for configuring the hair highlight special effect in the image preview region; and receive a dyeing region configuration parameter input based on the region configuration item, and display a dyed preview image after dyeing a target dyeing region corresponding to the dyeing region configuration parameter in the image to be processed in the image preview region.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be illustrated as “a unit for acquiring at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, example one provides an image processing method, the method includes:
in response to a received special effect configuration triggering operation for configuring a hair highlight special effect, displaying a highlight special effect configuration interface, in which the highlight special effect configuration interface displays an image preview region and at least one highlight configuration item, and the highlight configuration item at least includes a region configuration item for configuring a dyeing region;
displaying an image to be processed for configuring the hair highlight special effect in the image preview region; and
receiving a dyeing region configuration parameter input based on the region configuration item, and displaying a dyed preview image after dyeing a target dyeing region corresponding to the dyeing region configuration parameter in the image to be processed in the image preview region.

According to one or more embodiments of the present disclosure, example two provides an image processing method, the method includes:
optionally, displaying the image to be processed for configuring the hair highlight special effect in the image preview region includes:
receiving an image upload operation input based on an image upload control in the image preview region, displaying an uploaded image in the image preview region, and taking the uploaded image as the image to be processed for configuring the hair highlight special effect; or,
receiving a video upload operation input based on a video upload control in the image preview region, displaying an uploaded video in the image preview region, and taking an image in the uploaded video that meets a preset condition as the image to be processed for configuring the hair highlight special effect.

According to one or more embodiments of the present disclosure, example three provides an image processing method, the method includes:
optionally, the highlight configuration item further includes at least one of a color configuration item and a transparency configuration item.

According to one or more embodiments of the present disclosure, example four provides an image processing method, the method includes:
optionally, receiving a color configuration operation input based on the color configuration item;
displaying the dyed preview image after dyeing the target dyeing region corresponding to the dyeing region configuration parameter in the image to be processed in the image preview region includes:
in the image preview region, displaying the dyed preview image after applying a target color corresponding to the color configuration operation to the target dyeing region corresponding to the dyeing region configuration parameter in the image to be processed.

According to one or more embodiments of the present disclosure, example five provides an image processing method, the method includes:
receiving a transparency configuration operation input based on the transparency configuration item;
displaying the dyed preview image after dyeing the target dyeing region corresponding to the dyeing region configuration parameter in the image to be processed in the image preview region includes:
in the image preview region, displaying the dyed preview image after applying a target color transparency corresponding to the transparency configuration operation to a target color dyed in the target dyeing region corresponding to the dyeing region configuration parameter in the image to be processed.

According to one or more embodiments of the present disclosure, example six provides an image processing method, the method includes:
optionally, after receiving the dyeing region configuration parameter input based on the region configuration item, and before displaying the dyed preview image after dyeing the target dyeing region corresponding to the dyeing region configuration parameter in the image to be processed in the image preview region, the method further includes:
obtaining a region mask texture map corresponding to the dyeing region configuration parameter, determining the target dyeing region corresponding to the dyeing region configuration parameter in the image to be processed according to the region mask texture map, and performing dyeing processing on the target dyeing region, to generate a dyed preview image.

According to one or more embodiments of the present disclosure, example seven provides an image processing method, the method includes:
optionally, the target mask texture map includes a mask texture map of all hair regions and a mask texture map of at least one local hair region.

According to one or more embodiments of the present disclosure, example eight provides an image processing method, the method includes:
optionally, performing dyeing processing on the target dyeing region includes:
determining a facial mask texture map of a facial region in the image to be processed, and performing dyeing processing on the target dyeing region according to the facial mask texture map.

According to one or more embodiments of the present disclosure, example nine provides an image processing method, the method includes:
optionally, performing dyeing processing on the target dyeing region according to the facial mask texture map includes:
determining an overlapping region between the target dyeing region and the facial mask texture map, and performing dyeing processing on a region of the target dyeing region other than the overlapping region.

According to one or more embodiments of the present disclosure, example ten provides an image processing method, the method includes:
optionally, performing dyeing processing on the region of the target dyeing region other than the overlapping region includes:
for each pixel in the region of the target dyeing region other than the overlapping region, fusing an original color value of the pixel with a color value of a color to be dyed in the target dyeing region, to obtain a target color value of the pixel.

According to one or more embodiments of the present disclosure, example eleven provides an image processing method, the method includes:
optionally, fusing the original color value of the pixel with the color value of the color to be dyed in the target dyeing region includes:
fusing the original color value of the pixel with the color value of the color to be dyed in the target dyeing region according to a preset fusion operation rule, in which the preset fusion operation rule includes at least one of sum operation, weighted sum operation, product operation, and weighted product operation.

According to one or more embodiments of the present disclosure, example twelve provides an image processing method,
optionally, the method further includes: adjusting the color to be dyed in the target dyeing region according to a preset color adjustment curve; and/or
adjusting a color of the target dyeing region after dyeing according to a preset color adjustment curve.

According to one or more embodiments of the present disclosure, example thirteen provides an image processing apparatus, the apparatus includes:
an interface display module, configured to display a highlight special effect configuration interface in response to a received special effect configuration triggering operation for configuring a hair highlight special effect, in which the highlight special effect configuration interface displays an image preview region and at least one highlight configuration item, and the highlight configuration item at least includes a region configuration item for configuring a dyeing region;
an image to be processed display module, configured to display an image to be processed for configuring the hair highlight special effect in the image preview region; and
a dyeing effect display module, configured to receive a dyeing region configuration parameter input based on the region configuration item, and display a dyed preview image after dyeing a target dyeing region corresponding to the dyeing region configuration parameter in the image to be processed in the image preview region.

1. An image processing method, comprising:
in response to a received special effect configuration triggering operation for configuring a hair highlight special effect, displaying a highlight special effect configuration interface, wherein the highlight special effect configuration interface displays an image preview region and at least one highlight configuration item, and the highlight configuration item at least comprises a region configuration item for configuring a dyeing region;
displaying an image to be processed for configuring the hair highlight special effect in the image preview region; and
receiving a dyeing region configuration parameter input based on the region configuration item, and displaying a dyed preview image after dyeing a target dyeing region corresponding to the dyeing region configuration parameter in the image to be processed in the image preview region.

2. The image processing method according to claim 1, wherein displaying the image to be processed for configuring the hair highlight special effect in the image preview region comprises:
receiving an image upload operation input based on an image upload control in the image preview region, displaying an uploaded image in the image preview region, and taking the uploaded image as the image to be processed for configuring the hair highlight special effect; or,
receiving a video upload operation input based on a video upload control in the image preview region, displaying an uploaded video in the image preview region, and taking an image in the uploaded video that meets a preset condition as the image to be processed for configuring the hair highlight special effect.

3. The image processing method according to claim 1, wherein the highlight configuration item further comprises at least one of a color configuration item and a transparency configuration item.

4. The image processing method according to claim 3, further comprising:
receiving a color configuration operation input based on the color configuration item;
displaying the dyed preview image after dyeing the target dyeing region corresponding to the dyeing region configuration parameter in the image to be processed in the image preview region comprises:
in the image preview region, displaying the dyed preview image after applying a target color corresponding to the color configuration operation to the target dyeing region corresponding to the dyeing region configuration parameter in the image to be processed.

5. The image processing method according to claim 3, further comprising:
receiving a transparency configuration operation input based on the transparency configuration item;
displaying the dyed preview image after dyeing the target dyeing region corresponding to the dyeing region configuration parameter in the image to be processed in the image preview region comprises:
in the image preview region, displaying the dyed preview image after applying a target color transparency corresponding to the transparency configuration operation to a target color dyed in the target dyeing region corresponding to the dyeing region configuration parameter in the image to be processed.

6. The image processing method according to claim 1, after receiving the dyeing region configuration parameter input based on the region configuration item, and before displaying the dyed preview image after dyeing the target dyeing region corresponding to the dyeing region configuration parameter in the image to be processed in the image preview region, the method further comprising:
obtaining a region mask texture map corresponding to the dyeing region configuration parameter, determining the target dyeing region corresponding to the dyeing region configuration parameter in the image to be processed according to the region mask texture map, and performing dyeing processing on the target dyeing region, to generate a dyed preview image.

7. The image processing method according to claim 6, wherein the target mask texture map comprises a mask texture map of all hair regions and a mask texture map of at least one local hair region.

8. The image processing method according to claim 6, wherein performing dyeing processing on the target dyeing region comprises:
determining a facial mask texture map of a facial region in the image to be processed, and performing dyeing processing on the target dyeing region according to the facial mask texture map.

9. The image processing method according to claim 8, wherein performing dyeing processing on the target dyeing region according to the facial mask texture map comprises:
determining an overlapping region between the target dyeing region and the facial mask texture map, and performing dyeing processing on a region of the target dyeing region other than the overlapping region.

10. The image processing method according to claim 9, wherein performing dyeing processing on the region of the target dyeing region other than the overlapping region comprises:
for each pixel in the region of the target dyeing region other than the overlapping region, fusing an original color value of the pixel with a color value of a color to be dyed in the target dyeing region, to obtain a target color value of the pixel.

11. The image processing method according to claim 10, wherein fusing the original color value of the pixel with the color value of the color to be dyed in the target dyeing region comprises:
fusing the original color value of the pixel with the color value of the color to be dyed in the target dyeing region according to a preset fusion operation rule, wherein the preset fusion operation rule comprises at least one of sum operation, weighted sum operation, product operation, and weighted product operation.

12. The image processing method according to claim 6, further comprising at least one of the following:
adjusting the color to be dyed in the target dyeing region according to a preset color adjustment curve;
adjusting a color of the target dyeing region after dyeing according to a preset color adjustment curve.

13. (canceled)

14. An electronic device, comprising:
at least one processor; and
a storage apparatus, configured to store programs,
the programs are executed by the processor to allow the processor to:
in response to a received special effect configuration triggering operation for configuring a hair highlight special effect, display a highlight special effect configuration interface, wherein the highlight special effect configuration interface displays an image preview region and at least one highlight configuration item, and the highlight configuration item at least comprises a region configuration item for configuring a dyeing region;
display an image to be processed for configuring the hair highlight special effect in the image preview region; and
receive a dyeing region configuration parameter input based on the region configuration item, and display a dyed preview image after dyeing a target dyeing region corresponding to the dyeing region configuration parameter in the image to be processed in the image preview region.

15. A storage medium, comprising computer executable instructions, wherein the computer executable instructions are executed by a computer processor to perform an image processing method, the method comprises:
in response to a received special effect configuration triggering operation for configuring a hair highlight special effect, displaying a highlight special effect configuration interface, wherein the highlight special effect configuration interface displays an image preview region and at least one highlight configuration item, and the highlight configuration item at least comprises a region configuration item for configuring a dyeing region;
displaying an image to be processed for configuring the hair highlight special effect in the image preview region; and
receiving a dyeing region configuration parameter input based on the region configuration item, and displaying a dyed preview image after dyeing a target dyeing region corresponding to the dyeing region configuration parameter in the image to be processed in the image preview region.
